(19) United States
(12) Patent Application Publication
(10) Pub. No.: US 2018/0213831 A1
(43) Pub. Date: Aug. 2, 2018

(54) LIGHTENED FAT AND ITS USE IN BREADMAKING AND PATISSERIE

(71) Applicant: Corbion Biotech, Inc., South San Francisco, CA (US)

(72) Inventors: Marie Delebarre, LA COUTURE (FR); Thomas Boursier, MONS EN BAROEUL (FR); Caroline Varlamoff, ANNOEULLIN (FR)

(21) Appl. No.: 15/940,846

(22) Filed: Mar. 29, 2018

Related U.S. Application Data
(63) Continuation of application No. 14/776,949, filed on Sep. 15, 2015, now abandoned.

(30) Foreign Application Priority Data
Mar. 15, 2013 (EP) 13159385.7
Jul. 1, 2013 (FR) 1356392

(51) Int. Cl. A23L 17/10; A21D 13/06; A23L 35/00; A23P 10/20; A23P 10/22; A23L 29/212; A23L 33/20; A23L 3/46; A23L 3/3463; A23D 7/005; A21D 13/068; A21D 13/066; A23L 17/60; A21D 2/36; A21D 2/18; A21D 2/16; A21D 13/40; A23P 10/40

(52) U.S. Cl. CPC A23L 17/10; A23V 2250/202; A23L 35/20; A23P 10/20; A23P 10/22; A23L 29/212; A23L 33/20; A23L 3/46; A23L 3/3463; A23D 7/0056; A21D 13/068; A21D 13/066; A23L 17/60; A21D 2/36; A21D 2/186; A21D 2/165; A21D 13/40; A23P 10/40; A23V 2002/00; A23V 2200/122; A23V 2200/124; A23V 2200/13; A23V 2200/254; A21D 13/06

(57) ABSTRACT

The invention concerns a lightened fat which is obtained by replacing some of the initial vegetable and/or animal fat with a non-animal raw material, a microalgal flour, and the uses thereof as novel product in the fields of breadmaking and/or patisserie and/or viennoiserie.

### FIELD OF THE INVENTION

The present invention relates to a reduced-fat-content fat obtained by replacing a part of the starting fat of vegetable and/or animal origin with a non-animal raw material, and also to the uses thereof as novel product in the fields of breadmaking and/or patisserie and/or Viennese pastry-making. The present invention also relates to the breadmaking, patisserie and/or Viennese pastry products obtained by using said reduced-fat-content fat in their recipes.

### TECHNOLOGICAL BACKGROUND

There is an extremely large number of cookie-trade/patisserie products (more than 800 references). Although a very large number of recipes exist, they often contain the same basic ingredients: flour, sugar, eggs and fats of animal and/or vegetable origin. Generally, patisserie products are defined as sweet preparations of worked pastry dough/cake mixture, baked in an oven and/or in a mold, having varied forms and toppings (cream, fruits), and encompass, inter alia, cakes and tarts. Furthermore, patisserie products are consumed either in the form of a dessert at the end of a meal, or as a snack during the day (in particular during afternoon tea or a tea party).

In parallel with patisserie, the term “Viennese pastries” is used for bakery products of which the production technique is close to that of bread or of puff pastry, but the ingredients of which give them a more fatty and sweeter nature which makes them closer to patisserie (eggs, butter and/or vegetable fats, milk, cream, sugar, etc.). Furthermore, the pastry is very often leavened pastry or puff pastry.

In essence, patisserie products and Viennese pastry products are often rich in simple carbohydrates and in fats, in particular saturated fats (resulting mainly from milk fats). As it happens, public health recommendations strongly encourage limiting the consumption of sugar, of sugar-rich foods and/or of fats.

However, fats of animal and/or vegetable origin play an important role in products intended for breadmaking, patisserie and Viennese pastry-making. Not only do they reveal and carry the flavor of the final products, but they determine the result of a series of technical characteristics such as, for example, the friability of a croissant or the good rich taste of a butter cake. They are known to be high in calories and, depending on their origin, not necessarily very good for the health, and yet they are impossible to do without since their dual technical and gustative role is so important, or even essential, to the final result of the product.

Furthermore, it is nevertheless necessary to consume a certain amount of fats daily in order to ensure that our body functions correctly. For example, oils and lipids provide calories and essential fatty acids which help the body to absorb liposoluble vitamins such as vitamins A, D, E and K. The type of lipid consumed is as important for the health as the amount consumed.

Consequently, it is strongly recommended to choose unsaturated lipids known to be good lipids. Consuming too many bad lipids, such as saturated lipids and trans lipids, can cause LDL cholesterol (Low-Density Lipoprotein or “bad” cholesterol) levels to rise and HDL cholesterol (High-Density Lipoprotein or “good” cholesterol) levels to decrease. This imbalance can cause an increase in the risks of arterial hypertension, of narrowing of the arteries (atherosclerosis), of heart attack and of stroke.

Among unsaturated lipids, monounsaturated lipids and polyunsaturated lipids are distinguished. It has been demonstrated that monounsaturated fats improve blood cholesterol levels. They are found in olive oil, canola oil and peanut oil, in non-hydrogenated margarine, in avocados and in certain nuts such as almonds, pistachios, cashew nuts, pecan nuts and hazelnuts. Polyunsaturated fats help the body to rid itself of recently produced cholesterol. Among said polyunsaturated fats are the omega-3 fats, which can prevent blood clots, reduce the risk of having a stroke and also reduce triglycerides, a type of fat in the blood linked to heart disease. The best sources of omega-3 are cold-water fish, and likewise canola and soybean oils, eggs rich in omega-3, linseeds, walnuts, pecan nuts and pine nuts. Also in this category of fats are omega-6 fats which help to reduce LDL cholesterol, but excessive consumption of which can also reduce HDL cholesterol. They should therefore be consumed in moderation. They are found in safflower, sunflower and corn oils, non-hydrogenated margarines, nuts such as almonds, pecan nuts and Brazil nuts, and sunflower seeds. Many prepared meals also contain them.

In parallel are saturated lipids, which are most commonly found in fatty meats, whole milk products, butter, lard, coconut oil and palm oil. These fats can increase the “bad” LDL cholesterol. Just like saturated fats, trans lipids cause LDL cholesterol to increase. Trans lipids are found in partially hydrogenated margarines, fried foods from fast food outlets (fries, doughnuts) and in numerous crackers, cookies and commercial patisserie products.

From the aforementioned, it can be retained that fats make foods more delicious and are essential to our health. However, when consumed in excess, they can have negative effects, in particular on the cardiac and vascular system. Butter, numerous vegetable oils and lipids contained in foods are different fats. Butter and the products which contain it, for instance patisserie products and Viennese pastries, provide especially fats referred to as saturated. When they are too abundant in our meals, they can result in an increase in bad cholesterol. Vegetable oils provide essential fatty acids. It is advantageous to use different oils in order to take advantage of their complementary advantages.

However, it is not so simple to replace butter in patisserie products and Viennese pastries. Butter makes it possible to soften the dough but also to weigh it down. It makes the crumb more moist and the crust thinner and more fondant, and provides a quite particular taste and a delicious aspect which are highly appreciated by consumers looking for products of quality and authenticity. It isolates the particles from the other ingredients which cannot bind to one another. Without it, the product becomes friable.

Thus, in the prior art, solutions have been described for replacing butter with fats which have a more positive image in terms of health, for example fats of vegetable origin. On the other hand, the products obtained are often described as being bland and having a texture which is barely, or even not at all, puffed for croissants for example.

Thus, the known solutions of the prior art very often result in products which have a poorer final quality, in terms of texture and taste in particular.

There is therefore a real need to partially or totally replace fats of animal and/or vegetable origin in recipes of breadmaking, patisserie and Viennese pastry products, so as to decrease the calorie content and the intake of bad fats. The solutions proposed should result in products which have the same organoleptic properties as the “conventional” products. Moreover, the solutions proposed should be able to be used by those skilled in the art without any drastic change in the recipes and preferably on a large scale, on online productions.

### SUMMARY OF THE INVENTION

Armed with this observation and after numerous research studies, the applicant company has to its credit met all the demands required and has found that such an objective can be achieved as long as a microalgal flour is used as ingredient in the formulation of a reduced-fat-content fat capable of partially replacing fats of vegetable and/or animal origin, and more particularly fats of animal origin such as butter, while at the same time maintaining the final qualities of the product obtained.

It is therefore to the credit of the applicant to have discovered that a microalgal flour can, surprisingly and unexpectedly compared with the prerequisites of the prior art, partially replace a part of the fats of animal and/or vegetable origin in breadmaking, patisserie and Viennese pastry products, while at the same time keeping the organoleptic qualities, in particular gustative, olfactory, visual and tactile properties, at least equivalent, or even superior, to those of conventional baked products containing these ingredients.

The present invention relates to a reduced-fat-content fat characterized in that at least 5% of its initial lipid content is replaced with a microalgal flour.

In one preferred embodiment of the invention, said reduced-fat-content fat is characterized in that at least 10% or at least 20% of its initial lipid content is replaced with a microalgal flour.

In a second embodiment, said reduced-fat-content fat is characterized in that at least 40% or at least 50% of its initial lipid content is replaced with a microalgal flour.

In an even more preferred mode, said reduced-fat-content fat is characterized in that at least 60% or at least 70% of its initial lipid content is replaced with a microalgal flour.

Preferably, the reduced-fat-content fat is characterized in that it comprises at least 40% of fat, preferably 60% or 70%, expressed by dry weight.

Preferably, the reduced-fat-content fat is characterized in that it comprises at most 95% by weight of fat, expressed by dry weight.

According to one preferential mode, the reduced-fat-content fat comprises from 50% to 95% of fat, expressed by dry weight.

According to the invention, the reduced-fat-content fat also contains a drinkable liquid. The drinkable liquid can be chosen from water, fruit juices, fruit nectars, vegetable juices, vegetable nectars, and sodas, and is preferably water.

According to the invention, the reduced-fat-content fat is also characterized in that it contains from 30% to 90% of fat of animal and/or vegetable origin and from 0.5% to 50% of microalgal flour, the percentages being indicated by weight of reduced-fat-content fat.

According to one preferred mode, the reduced-fat-content fat is characterized in that it contains from 30% to 90% of fat of animal and/or vegetable origin and from 0.5% to 50% of microalgal flour and from 1% to 40% of drinkable liquid, the percentages being indicated by weight of reduced-fat-content fat.

In one particular embodiment, the reduced-fat-content fat is characterized in that the microalgal flour is in the form of granules having one or more of the following characteristics, preferably all three:
a monomodal particle size distribution, measured on a Coulter® LS laser particle size analyzer, of between 2 and 400 μm, centered on a particle diameter (D mode) between 5 and 15 μm,
flow grades, determined according to a test A, between 0.5% and 60% by weight for the oversize at 2000 μm, between 0.5% and 60% by weight for the oversize at 1400 μm and between 0.5% and 95% by weight for the oversize at 800 μm,
a degree of wettability, expressed according to a test B, by the height of the product decanted in a beaker, at a value of between 0 and 4 cm, preferably between 0 and 2 cm, and more preferentially between 0 and 0.5 cm.

Preferably, the microalgal flour is a flour of microalgae of the Chlorella genus, and more particularly of the Chlorella protothecoides species.

Preferably, the microalgal flour contains at least 12%, at least 25%, at least 50% or at least 75% by dry weight of lipids.

Another aspect of the invention also relates to a process for preparing a reduced-fat-content fat as described in the present document, characterized in that it comprises:
incorporating a microalgal flour, and optionally a drinkable liquid, into a fat of animal and/or vegetable origin as replacement for a part of said fats, and
cold storage.

The process may itself also be characterized in that it comprises:
mixing a microalgal flour and water with a fat of animal and/or vegetable origin, and preferably butter,
storage at a temperature below 10° C., and preferably below 5° C., for a period greater than 5 hours, and preferably greater than 10 hours.

More particularly, the process for preparing a reduced-fat-content fat can be characterized in that the mixing of microalgal flour and water with the fat of animal and/or vegetable origin comprises
mixing microalgal flour and water, at a ratio which can range from 1:9 to 9:1, preferentially 1:3 to 1:2, and
incorporating the previously rehydrated microalgal flour into a fat of animal and/or vegetable origin as a replacement for a part of said fat.

Another aspect of the present invention relates to a process for preparing a breadmaking, patisserie and/or Viennese pastry product, characterized in that it contains a reduced-fat-content fat as partial replacement for fats of animal and/or vegetable origin.

Said process for preparing a breadmaking product is also characterized in that it comprises:
mixing the various ingredients until a dough is obtained, and
baking said dough.

Another aspect of the invention relates to the use of a reduced-fat-content fat as partial replacement for fats of animal and/or vegetable origin in the preparation of ganache and/or filling creams. The ganache and/or filling creams are preferably also intended for the patisserie sector.

Finally, a last aspect of the invention relates to the use of a reduced-fat-content fat as partial replacement for fats of animal and/or vegetable origin in a process for preparing a breadmaking, patisserie and/or Viennese pastry product.

### DETAILED DESCRIPTION OF EMBODIMENTS

Thus, a subject of the present invention is a reduced-fat-content fat characterized in that at least 5% of its initial lipid content is replaced with a microalgal flour.

In one preferred embodiment of the invention, said reduced-fat-content fat is characterized in that at least 10% or at least 20% of its initial lipid content is replaced with a microalgal flour.

In a second embodiment, said reduced-fat-content fat is characterized in that at least 40% or at least 50% of its initial lipid content is replaced with a microalgal flour.

In an even more preferred mode, said reduced-fat-content fat is characterized in that at least 60% or at least 70% of its initial lipid content is replaced with a microalgal flour.

In the present application, the name “reduced-fat-content fat” used should be understood in its broadest interpretation and as denoting a fat in which a part of its lipid content has been replaced with microalgal flour, which can replace fats of animal and/or vegetable origin conventionally used in the fields of breadmaking, patisserie and Viennese pastry-making.

The reduced-fat-content fat is generally in the form of a soft solid at ambient temperature. Preferably, in the context of the present document, the reduced-fat-content fat comprises at least 40% of fat, for example at least 40%, 45%, 50%, 55%, 60%, 65% or 70% of fat, preferably at least 60% or 70%, expressed by dry weight.

According to the invention, the reduced-fat-content fat comprises from 50% to 95% of fat, expressed by dry weight.

In a second preferred embodiment of the invention, the reduced-fat-content fat is characterized in that it also contains a drinkable liquid. In particular, said reduced-fat-content fat can be characterized in that it contains from 0.5% to 50% of microalgal flour and from 1% to 40% of drinkable liquid, the percentages being indicated by weight of reduced-fat-content fat.

For the purposes of the invention, the term “drinkable liquid” should be understood in its broadest interpretation and as denoting, for example and in a nonlimiting manner, water, fruit juices, fruit nectars, vegetable juices, vegetable nectars, and sodas. According to one preferred mode of the invention, the drinkable liquid is water, it being possible for said water to be spring water, mineral water, naturally sparkling water or water that is sparkling through the addition of carbon dioxide, or still water.

The present invention therefore preferably relates to a reduced-fat-content fat containing microalgal flour and a drinkable liquid partially replacing fats of vegetable and/or animal origin, and more particularly fats of animal origin such as butter, and which can be used in food products, and more particularly in breadmaking, patisserie or Viennese pastry products.

The term “partially” is intended to mean that, in comparison with the recipe used, the content of the ingredient replaced is reduced by at least 10%, 20%, 30%, 40%, 50%, 60%, 70%, 80% or 90% by weight, for example by approximately 10%, 20%, 30%, 40%, 50%, 60%, 70%, 80% or 90% by weight. The term “partially” excludes the total replacement of the ingredient. In particular, the degrees of replacement can be between 5% and 95%, between 10% or 20% and 80% or 95%, between 40% or 50% and 80% or 95%.

The reduced-fat-content fat of the present invention is characterized in that it contains from 30% to 90% of fat of animal and/or vegetable origin and 0.5% to 50% of microalgae flour.

In one preferred embodiment of the invention, the reduced-fat-content fat contains from 30% to 90% of fat of animal and/or vegetable origin and from 0.5% to 50% of microalgae flour and from 1% to 40% of drinkable liquid.

The percentages indicated are percentages by weight relative to the total weight of the reduced-fat-content fat.

The reduced-fat-content fat according to the invention contains microalgae flour, in particular at least 0.5%, 1%, 5%, 10%, 20%, 30%, 40% or 50% by weight of the reduced-fat-content fat. Thus, the reduced-fat-content fat according to the invention contains microalgae flour in an amount of between 0.5% and 50% or between 1% or 5% and 40% or 50% or between 5% or 10% and 40% or 50% or between 10% or 20% and 30% or 40% by weight of the reduced-fat-content fat.

It should be noted, in the present invention, that the microalgae flour replaces a part of the fats of origin present in the fat traditionally used. This makes it possible to reduce the calorie content of the fat used in the recipes, to modify the lipid profile thereof by reducing in particular the provision of bad fats.

In one preferred embodiment, the sum of the constituents consisting of the microalgae flour and the drinkable liquid represents at least 1.5%, 5%, 10%, 15%, 20%, 30%, 40%, 60%, 80%, 90% by weight of the reduced-fat-content fat. In particular, the sum of the constituents can represent between 1.5% or 5% and 80% or 90%, or between 10% or 15% and 60% or 80%, or between 20% or 30% and 60% or 80% by weight of the reduced-fat-content fat.

Algae are among the first organisms which appeared on Earth, and are defined as eukaryotic organisms devoid of roots, stem and leaf, but having chlorophyll and also other secondary pigments in oxygen-producing photosynthesis. They are blue, red, yellow, golden and brown or else green. They represent more than 90% of marine plants and 18% of the plant kingdom, with their 40 000 to 45 000 species. Algae are organisms that are extremely varied both in terms of their size and their shape and in terms of their cell structure. They live in an aquatic or very humid medium. They contain numerous vitamins and trace elements, and are true concentrates of active agents that stimulate and are beneficial to health and beauty. They have anti-inflammatory, moisturizing, softening, regenerating, firming and anti-aging properties. They also have “technological” characteristics which make it possible to give a food product texture. Indeed, the famous additives E400 to E407 are in fact only compounds extracted from algae, the thickening, gelling, emulsifying and stabilizing properties of which are used.

Among the algae, macroalgae and microalgae can be distinguished, in particular single-celled microscopic algae, which are photosynthetic or non-photosynthetic, and of marine or non-marine origin, cultured in particular for their applications in biofuel or in the food sector. For example, spirulina (Arthrospira platensis) is cultured in open lagoons (under phototrophic conditions) for use as a food supplement or incorporated in small amounts into confectionery products or drinks (generally less than 0.5% w/w). Other lipid-rich microalgae, including certain species of Chlorella, are also very popular in Asian countries as food supplements (mention may be made of microalgae of the Crypthecodinium or Schizochytrium genus). The production and use of microalgal flours is described in applications WO 2010/120923 and WO 2010/045368.

For the purposes of the present invention, the term “microalgal flour” should be understood in its broadest interpretation and as denoting, for example, a composition comprising a plurality of particles of microalgal biomass. The microalgal biomass is derived from microalgal cells, which may be whole or broken, or a mixture of whole and broken cells. It is understood in the present document that the microalgal flour denotes a product essentially composed of microalgal biomass, i.e. at least 90%, 95% or 99%. In one preferred embodiment, the microalgal flour comprises only microalgal biomass.

The present invention thus relates to the microalgal biomass suitable for human consumption which is rich in nutrients, in particular in lipids and/or proteins.

The invention also relates to a microalgal flour which can be incorporated into food products in which the lipid and/or protein content of the microalgal flour can totally or partially replace the oils and/or fats and/or proteins present in conventional food products.

The lipid fraction of the microalgal flour, which may be composed essentially of monounsaturated oils, thus provides nutritional and health advantages compared with the saturated, hydrogenated and polyunsaturated oils often found in conventional food products.

The protein fraction of the microalgal flour which contains many amino acids essential to human and animal well-being therefore also provides advantageous and not insignificant nutritional and health advantages.

For the purposes of the invention, the microalgae under consideration are species which produce appropriate oils and/or lipids and/or proteins.

According to the invention, the microalgal biomass comprises at least 10% by dry weight of lipids, preferably at least 12% and even more preferentially from 25% to 35% or more by dry weight of lipids.

Thus, according to the present invention, the expression “rich in lipids” should be interpreted as referring to contents of at least 10% by dry weight of lipids, preferably of at least 12% by dry weight of lipids and even more preferentially contents of at least 25% to 35% or more by dry weight of lipids.

According to one preferential mode of the invention, the microalgal biomass contains at least 12%, at least 25%, at least 50% or at least 75% by dry weight of lipids.

According to another embodiment of the invention, the microalgal biomass contains at least 30% by dry weight of proteins, at least 40% or at least 45% by dry weight of proteins.

Thus, depending on the recipe of the product, the baker/pastry maker will be able to choose to incorporate into his baked-product recipe instead a microalgal flour having a high content of lipids or instead a microalgal flour having a high protein content, a microalgal flour having both a high lipid and a high protein content, or else a mixture of the two types of microalgal flours.

According to another preferential mode of the invention, the microalgae belong to the Chlorella genus.

Chlorella (or Chlorella) is a freshwater microscopic green single-celled alga or microalga which appeared on Earth more than 3 billion years ago, belonging to the Chlorophyte branch. Chlorella possesses the greatest concentration of chlorophyll of all plants, and it has a considerable photosynthesis capacity. Since its discovery, chlorella has not ceased to generate considerable interest throughout the world, and today it is produced on a large scale for uses in food and nutritional supplements. Indeed, chlorella contains more than 60% of proteins which contain many amino acids essential to human and animal well-being. Chlorella also contains many vitamins (A, beta-carotene, B1: thiamine, B2: riboflavin, B3: niacin, B5: pantothenic acid, B6: pyridoxine, B9: folic acid, B12: cobalamin, vitamin C: ascorbic acid, vitamin E: tocopherol, vitamin K: phylloquinone), lutein (carotenoid family, powerful antioxidant) and minerals, including calcium, iron, phosphorus, manganese, potassium, copper and zinc. In addition, chlorella contains certain omega-type polyunsaturated fatty acids essential to good cardiac and brain function and to the prevention of numerous diseases such as cancer, diabetes or obesity.

There are a large number of benefits related to the consumption of chlorella. It is a food supplement used daily in Japan by 4 million people. It is used to such an extent that the Japanese government has classified it as a “food of national interest”.

Optionally, the microalgae used may be chosen, non-exhaustively, from Chlorella protothecoides, Chlorella kessleri, Chlorella minutissima, Chlorella sp., Chlorella sorokiniama, Chlorella luteoviridis, Chlorella vulgaris, Chlorella reisiglii, Chlorella ellipsoidea, Chlorella saccarophila, Parachlorella kessleri, Parachlorella beijerinkii, Prototheca stagnora and Prototheca moriformis. Preferably, the microalgae used according to the invention belong to the Chlorella protothecoides species.

In the context of the invention, Chlorella protothecoides is chosen because of its high lipid composition.

In a secondary embodiment, Chlorella protothecoides is also chosen because of its high protein composition.

In the microalgal flour, the cell walls of the microalgae and/or the cell debris of the latter may optionally encapsulate the lipids at least until the food product containing it is baked, thereby increasing the lifetime of the lipids.

The microalgal flour also provides other benefits, such as micronutrients, dietary fibers (soluble and insoluble carbohydrates), phospholipids, glycoproteins, phytosterols, tocopherols, tocotrienols and selenium.

According to one embodiment of the invention, the microalgae can be modified so as to reduce pigment production, or even totally inhibit it. For example, Chlorella protothecoides can be modified by UV-mutagenesis and/or chemical mutagenesis so as to have a reduced pigment content or to be devoid of pigments.

It may in fact be particularly advantageous to have microalgae free of pigment so as to avoid obtaining a more or less marked green color in the baked products in which the microalgal flour is used.

Since the microalgae are intended for the production of flours intended for food formulations, according to one preferred embodiment of the invention, the microalgae do not undergo any genetic modification, for instance mutagenesis, transgenesis, genetic engineering and/or chemical engineering. Thus, the microalgae have not undergone modifications of their genome by any molecular biology techniques whatsoever.

According to this preferred mode, the algae intended for the production of the microalgal flour have the GRAS status. The GRAS (Generally Recognized As Safe) concept, created in 1958 by the Food and Drug Administration (FDA), allows the regulation of substances or extracts added to foods and which are considered to be harmless by a panel of experts.

The appropriate culture conditions to be used are in particular described in the article by Ikuro Shihira-Ishikawa and Eiji Hase, “Nutritional Control of Cell Pigmentation in Chlorella protothecoides with special reference to the degeneration of chloroplast induced by glucose”, Plant and Cell Physiology, 5, 1964.

This article describes in particular that all the color grades can be produced by Chlorella protothecoides (colorless, yellow, yellowish green, and green) by varying the nitrogen and carbon sources and ratios. In particular, “washed-out” and “colorless” cells are obtained using culture media which are glucose-rich and nitrogen-poor. The distinction between colorless cells and yellow cells is made in this article. Furthermore, the washed-out cells cultured in excess glucose and limited nitrogen have a high growth rate. Furthermore, these cells contain high amounts of lipids.

Other articles, such as the one by Han Xu, Xiaoling Miao, Qingyu Wu, “High quality biodiesel production from a microalga Chlorella protothecoides by heterotrophic growth in fermenters”, Journal of Biotechnology, 126, (2006), 499-507, describe that heterotrophic culture conditions, i.e. in the absence of light, make it possible to obtain an increased biomass with a high content of lipids in the microalgal cells.

The solid and liquid growth media are generally available in the literature, and the recommendations for preparing the particular media which are suitable for a large variety of microorganism strains can be found, for example, online at www.utex.org/, a website maintained by the University of Texas at Austin for its algal culture collection (UTEX).

In the light of their general knowledge and the abovementioned prior art, those skilled in the art responsible for culturing the microalgal cells will be entirely capable of adjusting the culture conditions in order to obtain a large biomass, rich in proteins and/or in lipids and either totally free of or with a reduced content of chlorophyll pigments.

According to the present invention, the microalgae are cultured in liquid medium in order to produce the biomass as such.

According to the present invention, the microalgae are cultured in a medium containing a carbon source and a nitrogen source, either in the presence of light, or in the absence of light.

According to one preferred mode of the invention, the microalgae are cultured in a medium containing a carbon source and a nitrogen source in the absence of light (heterotrophic conditions).

The production of biomass is carried out in fermenters (or bioreactors). The specific examples of bioreactors, the culture conditions, and the heterotrophic growth and methods of propagation can be combined in any appropriate manner in order to improve the efficiency of the microbial growth and the lipids and/or of protein production.

In order to prepare the biomass for use in food compositions, the biomass obtained at the end of fermentation is concentrated or harvested, from the fermentation medium. At the time of the harvesting of the microalgal biomass from the fermentation medium, the biomass comprises intact cells which are mostly in suspension in an aqueous culture medium.

In order to concentrate the biomass, a solid-liquid separation step is then carried out by filtration, by centrifugation or by any means known, moreover, to those skilled in the art.

After concentration, the microalgal biomass can be treated in order to produce vacuum-packed cakes, algal flakes, algal homogenates, algal powder, algal flour or algal oil.

The microalgal biomass is also dried in order to facilitate the subsequent treatment or for use of the biomass in its various applications, in particular food applications.

Various textures and flavors can be conferred on food products, depending on whether the algal biomass is dried, and if it is, depending on the drying method used. Reference may be made to patents U.S. Pat. No. 6,607,900 and U.S. Pat. No. 6,372,460 for examples.

According to the present invention, the microalgal flour can be prepared from the concentrated microalgal biomass which has been mechanically lyzed and homogenized, the homogenate then being spray-dried or flash-dried.

According to one embodiment of the invention, the cells used for the production of microalgal flour are lyzed in order to release their oil or lipids. The cell walls and the intracellular components are milled or reduced, for example using a homogenizer, to non-agglomerated cell particles or debris. According to one preferential mode of the invention, the resulting particles have an average size of less than 500 μm, 100 μm or even 10 μm or less.

According to another embodiment of the invention, the lyzed cells can also be dried.

For example, a pressure disruptor can be used to pump a suspension containing the cells through a restricted orifice so as to lyze the cells. A high pressure (up to 1500 bar) is applied, followed by an instantaneous expansion through a nozzle. The cells can be broken by three different mechanisms: running into the valve, high shear of the liquid in the orifice, and a sudden drop in pressure at the outlet, causing the cell to explode.

The method releases the intracellular molecules.

A Niro homogenizer (GEA Niro Soavi) (or any other high-pressure homogenizer) can be used to break cells.

This treatment of the algal biomass under high pressure (approximately 1500 bar) generally lyzes more than 90% of the cells and reduces the size of the particles to less than 5 microns.

According to one embodiment of the invention, the pressure applied is from 900 bar to 1200 bar. Preferentially, the pressure applied is 1100 bar.

According to another embodiment, and in order to increase the percentage of lyzed cells, the microalgal biomass may undergo a high-pressure double treatment, or even more (triple treatment, etc.).

According to one preferred mode, a double homogenization is used in order to increase the percentage of lyzed cells greater than 50%, greater than 75% or greater than 90%. The percentage of lyzed cells of approximately 95% has been observed by means of this double treatment.

Lysis of the microalgal cells is optional but preferred when a flour rich in lipids (e.g. greater than 10%) is desired.

According to one embodiment of the invention, the microalgal flour is in the form of non-lyzed cells.

According to another embodiment of the invention, partial lysis is desired, i.e. the microalgal flour is in the form of partially lyzed cells and contains from 25% to 75% of lyzed cells.

According to another embodiment of the invention, maximum or even total lysis is desired, i.e. the microalgal flour is in the form of strongly or even totally lyzed cells and contains 85% or more of lyzed cells, preferably more than 90%.

Thus, in the present invention, the microalgal flour is capable of being in a non-milled form up to an extremely milled form with degrees of milling greater than 95%. Specific examples relate to microalgal flours having degrees of milling of 50%, 85% or 95% of cell lysis, preferably 85% or 95%.

In another embodiment of the invention, a protein-rich microalgal flour is produced. This protein-rich microalgal flour may be in the form of non-lyzed cells (non-lyzed and non-milled intact cells).

Alternatively, a ball mill is instead used. In this type of mill, the cells are agitated in suspension with small abrasive particles. The breaking of the cells is caused by the shear forces, the milling between the beads, and the collisions with beads. In fact, these beads break the cells so as to release the cell content therefrom. The description of an appropriate ball mill is, for example, given in the patent U.S. Pat. No. 5,330,913.

A suspension of particles, optionally of smaller size than the cells of origin, is obtained in the form of an “oil-in-water” emulsion. This emulsion can then be spray-dried and the water is eliminated, leaving a dry powder containing the cell debris and the lipids. After drying, the water content or the moisture content of the powder is generally less than 10%, preferentially less than 5% and more preferably less than 3% by weight.

However, the production of a dry powder which is tacky and flows with difficulty, since it contains oil in a content of 10%, 25% or even 50% by weight of the dry powder, is lamentable. Various flow agents (including silica-derived products) can then be added.

Problems of water-dispersibility of the dried biomass flours, which then have poorer wettability properties, may also be encountered.

The applicant company has developed microalgal flour granules which have a particular particle size distribution, and notable flow and wettability properties. In particular, these granules make it possible to stabilize the microalgal flour and to allow their easy, large-scale incorporation into food products which must remain delicious and nutritious.

The microalgal flour granules in accordance with the invention are thus characterized in that they have one or more of the following characteristics:
a monomodal particle size distribution, measured on a Coulter® LS laser particle size analyzer, of between 2 and 400 μm, centered on a particle diameter (D mode) between 5 and 15 μm,
flow grades, determined according to a test A, between 0.5% and 60% by weight for the oversize at 2000 μm, between 0.5% and 60% by weight for the oversize at 1400 μm and between 0.5% and 95% by weight for the oversize at 800 μm,
a degree of wettability, expressed according to a test B, by the height of the product decanted in a beaker, at a value of between 0 and 4 cm, preferably between 0 and 2 cm, and more preferentially between 0 and 0.5 cm.

Preferably, the microalgal flour granules have two of these characteristics, and even more preferably the three characteristics. According to one advantageous embodiment of the invention, the microalgal flour granules are characterized in that they have at least the three characteristics mentioned above.

The microalgal flour granules according to the invention can first be characterized by their particle size distribution, and particularly on the basis of their particle diameter. This measurement is carried out on a Coulter® LS laser particle size analyzer, equipped with its small volume dispersion module or SVM (125 ml), according to the constructor's specifications (in the “Small Volume Module Operating instructions”).

The microalgal flour particles are agglomerated during their preparation. Despite this agglomeration, the microalgal flour granules according to the invention also have entirely satisfactory flow properties, according to a test A.

These flow properties confer many advantages in the production of food products using the microalgal flour. For example, during the preparation of food products, many precise measurements of amount of flour must be carried out, and the flour aliquots are often prepared automatically. It is therefore essential for the flour and more particularly the microalgal flour to have a good flowability, so as not to cake in industrial automated systems.

The test A consists in measuring the degree of cohesion of the microalgal flour granules according to the invention.

The test A first of all consists in sieving the microalgal flour granules according to the invention on a sieve with a mesh opening of 800 μm. The flour granules which have a size of less than 800 μm are then recovered and placed in a closed container, and undergo mixing by epicycloidal motion using a Turbula laboratory mixer, type T2C. By virtue of this mixing, according to their own characteristics, the microalgal flour granules in accordance with the invention express their propensities to agglomerate or to repel one another.

The granules thus mixed are then deposited on a 3-sieve column (2000 μm; 1400 μm; 800 μm) for further sieving.

Once the sieving has ended, the oversize on each sieve is quantified and the result gives an illustration of the “cohesive” or “tacky” nature of the microalgal flour granules.

Thus, a free-flowing, and therefore not very cohesive, granule powder will virtually not be stopped by the large-opening sieves, but will be increasingly stopped the tighter the meshes of said sieves.

The protocol for measuring the particle size according to the test A is the following:
sieving the required amount of product on an 800 μm sieve in order to recover 50 g of product having a size less than 800 μm,
placing these 50 g of flour granules having a size of less than 800 μm in a glass jar with a volume of 1 liter (Ref. BVBL Verrerie Villeurbannaise-Villeurbanne France) and closing the lid,
placing this jar in the Turbula mixer, model T2C, adjusted to the speed of 42 rpm (Willy A. Bachofen Sarl-Sausheim-France) and mixing for 5 minutes,
preparing a 3-sieve column (of the brand Saulas—Diameter 200 mm; Paisy Cosdon-France) which will be placed on a Fritsch siever, model Pulverisette type 00.502; details of the assembly starting from the bottom to the top: siever, sieve bottom, 800 μm sieve, 1400 μm sieve, 2000 μm sieve, siever lid,
depositing the powder resulting from the mixing on the top of the column (2000 μm sieve), closing with the siever lid and sieving for 5 minutes on the Fritsch siever, with an amplitude 5 in the permanent position,
weighing the oversize on each sieve.

The microalgal flour granules according to the invention then exhibit:
between 0.5% and 60% by weight for the oversize at 2000 μm,
between 0.5% and 60% by weight for the oversize at 1400 μm, and
between 0.5% and 95% by weight for the oversize at 800 μm.

By way of comparison, the microalgal flour powders prepared by conventional drying techniques (single-effect spray-drying) have, for their part, a tacky aspect, of low fluidity, which results in a behavior according to the test A:
between 50% and 90% by weight of oversize on 2000 μm,
between 0.5% and 30% by weight of oversize on 1400 μm,
between 5% and 40% by weight of oversize on 800 μm.

In other words, a majority of the microalgal flour powder (more than 50% of the powder) does not manage to cross the threshold of 2000 μm, although it was initially sieved on 800 μm.

These results demonstrate that the conventional drying techniques result instead in the production of very cohesive powders, since, after mixing, using little mechanical energy (sieving time of barely 5 min), particles less than 800 μm do not manage to pass through a 2000 μm sieve, with an opening which is nevertheless 2.5 times larger.

It is readily deduced therefrom that a conventional powder, exhibiting such a behavior, is not easy to use in a preparation where uniform distribution of the ingredients is recommended.

Conversely, the microalgal flours according to the present invention are easier to use since they are less tacky. This less tacky nature is obvious in the light of the numerous measurements including the small size of the granules, the high wettability and the improved flow.

The microalgal flour granules according to the invention exhibit only a low oversize (<50%) on 2000 μm for the family of granules of fine particle size and virtually no oversize (5%) for the family of granules of coarse particle size. It is therefore demonstrated that the microalgal flour particles produced according to the methods described in the present invention are less tacky than the microalgal flours prepared according to the conventional methods described in the prior art.

The microalgal flour granules according to the invention are, finally, characterized by a notable degree of wettability, according to a test B.

The wettability is a technological property very often used to characterize a powder resuspended in water, for example in dairy industries.

It reflects the ability of a powder to become immersed after having been deposited at the surface of water (Haugaard Sorensen et al. “Méthodes d'analyse des produits laitiers déshydratés” [“Methods for analyzing dehydrated milk products” ], Niro A/S (publisher), Copenhagen, Denmark, 1978), and thus reflects the capacity of the powder to absorb water at its surface (Cayot P. and Lorient D., “Structures et technofonctions des protéines du lait” [“Structures and technofunctions of milk proteins” ]. Paris: Airlait Recherches: Tec and Doc, Lavoisier, 1998).

The measurement of this index conventionally consists in measuring the time required for a certain amount of powder to penetrate into the water through its free surface at rest. According to Haugaard Sorensen et al. (1978), a powder is said to be “wettable” if its IM (Index of Wettability) is less than 20 seconds.

The swelling ability of the powder should also be associated with the wettability. This is because, when a powder absorbs water, it gradually swells. The structure of the powder then disappears when the various constituents are solubilized or dispersed.

Among the factors which influence wettability are the presence of large primary particles, the reintroduction of fines, the density of the powder, the porosity and the capillarity of the powder particles and also the presence of air, the presence of fats at the surface of the powder particles and the reconstitution conditions.

The test B developed by the applicant company consists here in considering more particularly the behavior of the microalgal flour powder when brought into contact with water, by measuring, after a certain contact time, the height of the powder which decants when placed at the surface of the water.

The protocol for this test is the following:
500 ml of demineralized water at 20° C. are placed in a low-form beaker of 600 ml (Fischerbrand FB 33114 beaker),
25 g of the microalgal flour powder are uniformly placed at the surface of the water, without mixing,
the behavior of the powder is observed after 3 h of contact,
the height of the product which has penetrated the surface of the water and which is decanted to the bottom of the beaker is measured.

A very cohesive, tacky powder of low wettability will remain at the surface of the liquid, while a powder of better wettability, which is less tacky, will decant more easily.

The microalgal flour granules according to the invention then have a degree of wettability, expressed according to this test B, by the height of the product decanted in a beaker, at a value of between 0 and 4 cm, preferably between 0 and 2 cm, and more preferentially between 0 and 0.5 cm.

By way of comparison, the flour of microalgae conventionally dried by single-effect spray-drying stays at the surface of the water, and does not hydrate sufficiently to be able to decant to the bottom of the beaker.

The microalgal flour granules according to the invention are also characterized by:
their bulk density,
their specific surface area and
their behavior after dispersibility in water.

The bulk density is determined according to a conventional method of measuring bulk density, i.e. by measuring the weight of an empty container (in grams) having a known volume, then by measuring the weight of the same container filled with the test product.

The difference between the weight of the filled container and the weight of the empty container, divided by the volume (in ml) of the container, gives the value of the bulk density.

For this test, the container having a volume of 100 ml that is used and the scraper and the measuring device that are sold by the company Hosokawa under the brand name Powder tester type PTE, by applying the method recommended in the “operating instructions” for measuring a bulk density.

Under these conditions, the microalgal flour granules in accordance with the invention have a bulk density of between 0.30 and 0.50 g/ml.

This bulk density value is all the more notable since the microalgal flour granules in accordance with the invention have a higher density than the flour of conventionally dried microalgae. Indeed, it is accepted that the density of a product will be all the lower if it is granulated by spray-drying, for example less than 0.30 g/ml.

However, although granulated, the products in accordance with the invention have a higher than expected bulk density.

The microalgal flour granules in accordance with the invention may also be characterized by their specific surface area.

The specific surface area is determined on the whole of the particle size distribution of the microalgal flour granules using a Quantachrome specific surface area analyzer, based on a test for absorption of nitrogen on the surface of the product subjected to the analysis, carried out on an SA3100 instrument from Beckmann Coulter, according to the technique described in the article BET Surface Area by Nitrogen Absorption by S. Brunauer et al. (Journal of American Chemical Society, 60, 309, 1938).

The microalgal flour granules in accordance with the invention, after degassing for 30 minutes at 30° C. under vacuum, then have a specific surface area of between 0.10 and 0.70 m²/g.

By way of comparison, the flour of microalgae dried by conventional spray-drying has a specific surface area according to BET of 0.65 m²/g.

It is therefore surprising to note that the microalgal flour granules, which are more dense than the conventional microalgal flour, have a specific surface area which is all the smaller since their size is large.

To the knowledge of the applicant company, the particular properties of the microalgal flour granules have never been described. The microalgal flour granules of the invention are therefore easily differentiated from the microalgal flours obtained by simple spray-drying.

The microalgal flour granules in accordance with the invention are capable of being obtained by means of a particular spray-drying process, which uses high-pressure spray nozzles in a parallel-flow tower which directs the particles to a moving belt located in the bottom of the tower. The material is then transported as a porous layer through post-drying and cooling zones, which give it a crunchy structure, like that of a cake, which breaks up at the end of the belt. The material is then processed to obtain the desired particle size. In order to carry out the granulation of the algal flour, according to this spray-drying principle, a Filtermat™ spray-dryer sold by the company GEA Niro or a Tetra Magna Prolac Dryer™ drying system sold by the company Tetra Pak can be used for example.

Surprisingly and unexpectedly, the applicant company has thus noted that the granulation of the microalgal flour by implementing, for example, this Filtermat™ process makes it possible not only to prepare a product in accordance with the invention with a high yield in terms of particle size distribution and of its flowability, but also to give it unexpected wettability properties without the need to use granulation binders or anti-caking agents (although they may be optionally used). Indeed, the processes previously described (such as single-effect spray-drying) do not make it possible to obtain all of the desired characteristics.

According to one preferred embodiment of the invention, the process for preparing the microalgal flour granules in accordance with the invention then comprises the following steps:
1) preparing an emulsion of microalgal flour with a solids content of between 15% and 40% by dry weight,
2) introducing this emulsion into a high-pressure homogenizer,
3) spraying in a vertical spray-dryer equipped with a moving belt at its base, and with a high-pressure nozzle in its upper part, while at the same time regulating:
a) the pressure applied at the level of the spray nozzles at values of more than 100 bar, preferably between 100 and 200 bar, and more preferably between 160 and 170 bar,
b) the input temperature between 150° C. and 250° C., preferably between 180° C. and 200° C., and
c) the output temperature in this spray-drying zone between 60° C. and 120° C., preferably between 60° C. and 110° C. and more preferably between 60° C. and 80° C.,
4) regulating the input temperatures of the drying zone on the moving belt between 40° C. and 90° C., preferably between 60° C. and 90° C., and the output temperature between 40° C. and 80° C., and regulating the input temperatures of the cooling zone at a temperature between 10° C. and 40° C., preferably between 10° C. and 25° C., and the output temperature between 20° C. and 80° C., preferably between 20° C. and 60° C.,
5) collecting the microalgal flour granules thus obtained.

The first step of the process of the invention consists in preparing a suspension of microalgal flour, preferably a lipid-rich microalgal flour (for example from 30% to 70%, preferably from 40% to 60%, of lipid by cell dry weight), in water with a solids content of between 15% and 40% by dry weight.

According to one preferential embodiment of the process for producing the microalgal flour according to the present invention, a biomass which can be at a concentration of between 130 g/l and 250 g/l, with a lipid content of approximately 50% by dry weight, a fiber content of from 10% to 50% by dry weight, a protein content of from 2% to 15% by dry weight, and a sugar content of less than 10% by weight, is obtained at the end of fermentation.

According to another embodiment of the process for producing the microalgal flour according to the present invention, a biomass which can be at a concentration of between 130 g/I and 250 g/l, with a protein content of approximately 50% by dry weight, a fiber content of from 10% to 50% by dry weight, a lipid content of from 10% to 20% by dry weight, and a sugar content of less than 10% by weight, is obtained at the end of fermentation.

According to the invention, the biomass extracted from the fermentation medium by any means known to those skilled in the art is then:
concentrated (for example by centrifugation),
optionally preserved by adding standard preservatives (sodium benzoate and potassium sorbate for example),
cellularly milled.

The emulsion can then be homogenized. This high-pressure homogenization of the emulsion can be accomplished in a two-stage device, for example a Gaulin homogenizer sold by the company APV, with a pressure of 100 to 250 bar at the first stage, and 10 to 60 bar at the second stage.

The suspension of flour thus homogenized is then sprayed in a vertical spray-dryer equipped with a moving belt at its base, and with a high-pressure nozzle in its upper part. The pressure applied at the level of the spray nozzles is regulated at values of more than 100 bar, preferably between 100 and 200 bar, more preferably between 160 and 170 bar, the input temperature is regulated so as to be between 150° C. and 250° C., preferably between 180° C. and 200° C., and the output temperature in this spray-drying zone is regulated so as to be between 60° C. and 120° C., preferably between 60° C. and 1100° C. and more preferably between 60° C. and 80° C.

The moving belt makes it possible to move the material through the post-drying and cooling zones. The input temperature of the drying zone on the moving belt is regulated between 40° C. and 90° C., preferably between 60° C. and 90° C., and the output temperature of the drying zone is regulated between 40° C. and 80° C., and the input temperature of the cooling zone is regulated preferably between 10° C. and 25° C., between 10° C. and 40° C., and the output temperature of the cooling zone is regulated between 20° C. and 80° C., preferably between 20° C. and 60° C.

The pressure applied and the input temperature of the drying zone are important parameters for determining the texture of the cake on the moving belt and therefore have an impact on the particle size distribution.

The microalgal flour granules according to the conditions of the preceding step of the process in accordance with the invention fall onto the moving belt with a residual moisture content of between 2% and 4%.

In order to bring the degree of moisture of the microalgal flour granules to the desired value of less than 4%, and more preferentially less than 2%, the applicant company has found that it is necessary to adhere to these drying- and cooling-zone temperature scales.

Optionally, an antioxidant (of butylhydroxyanisole (BHA) or butylhydroxytoluene (BHT) type, or others known for a food use) can be added before the drying step in order to maintain the freshness and the preservation.

The last step of the process in accordance with the invention consists, finally, in collecting the microalgal flour granules thus obtained.

Thus, the present invention also relates to the microalgal flour granules as defined in the present invention or as obtained by implementing the process described in the present invention.

According to one preferred mode of the invention, the microalgal flour granules contain at least 10% by dry weight of lipids, preferably at least 12% and even more preferentially from 25% to 35% or more by dry weight of lipids.

In one particular mode of the invention, the microalgal flour granules contain at least 25% of lipids, or at least 55% of lipids, expressed by dry weight.

The microalgal flour granules obtained according to the process described above are capable of containing intact microalgal cells, a mixture of intact microalgal cells and of milled cells or mainly milled microalgal cells.

In one embodiment of the present invention, non-extensive lysis is desired, i.e. the percentage of intact cells contained in the microalgal flour granules is between 25% and 75%.

According to another embodiment of the invention, partial lysis is desired, i.e. from 25% to 75% of lyzed cells present in the microalgal flour.

According to another embodiment of the invention, total lysis is desired, i.e. the microalgal flour contains 85% or more of lyzed cells, preferably 90% or more.

Thus, according to the desired applications, a microalgal flour which has a greater or lower content of lyzed cells will be chosen.

As previously described and according to one preferred mode of the invention, the microalgal flour is in the form of microalgal flour granules. Said granules are produced according to the process as described above.

The invention therefore also relates to the use of a microalgal flour in the preparation of a reduced-fat-content fat and to the incorporation thereof into food products containing fats of vegetable and/or animal origin generally.

In one preferential mode, the invention is intended for food products of the fields of cookie-making, patisserie and Viennese pastry-making.

In the present invention, the terms “baked product” and “breadmaking product” and also the terms “breadmaking”, “patisserie”, “Viennese pastry-making” and “cookie-making” should be interpreted broadly, as referring generally to the field of the production of products baked in an oven using starch-based fermented doughs, and also to the fields of breadmaking and Viennese pastry-making.

In these fields, fats of vegetable and/or animal origin, and more particularly butter, have a predominant place and it is very difficult to replace them.

In the present invention, the term “fat of animal and/or vegetable origin” should be understood in its broadest interpretation and as denoting, for example, in a nonlimiting manner, any product chosen from butters, margarines or oils.

According to Article 1 of the Decree of Dec. 30, 1988, the name “butter” is reserved for the dairy product of water-in-fat emulsion type, obtained by physical processes and the constituents of which are of dairy origin. It must represent, for 100 g of final product, at least 82 g of butyric fat, at most 2 g of non-fat solids and at most 16 g of water. It results from the churning of milk cream, after maturation thereof. The butters may be dry or fatty butters. A dry butter is composed essentially of triglycerides containing fatty acids with a high melting point. A fatty butter is composed essentially of triglycerides containing fatty acids with a low melting point. The butters may also be fractionated. In order to compensate for the differences in plasticity of butter according to the season, manufacturers have improved butter by fractionating the fatty acid crystallization. The advantage for professionals is obvious. They have available throughout the year a raw material which is not only constant in terms of quality, but especially specially suited to their productions. The other modification carried out by manufacturers is concentration. All the water is removed from the butter (16% in a fresh butter). A concentrated butter, containing on average 99% fat, which stores very well, is obtained. This concentrated butter, which may or may not be fractionated, always has a tracer added to it, as soon as it is produced, in order to distinguish it from fresh butter, which itself is not concentrated. Finally, the butter may also be powdered.

The principal advantage of butter is the values that it conveys, values which are identical to those developed by craftsmen: quality raw material, noble product, benefiting from a strong image among consumers. Furthermore, it allows the final products to bear the name “with butter”. In addition, in terms of taste, it has no equal.

According to the Decree of Dec. 30, 1988, the name “margarine” is reserved for the product obtained by mixing fat and water or milk or milk derivatives, which is in the form of an emulsion containing at least 82% of fat, of which at most 10% is of dairy origin. That said, most commonly, margarine is an oil-in-water emulsion supplemented with adjuvants of soya lecithin type.

According to the present invention, the fat of vegetable origin also denotes oils. Produced mainly from oleaginous plants, vegetable oils are the leading fatty substances consumed throughout the world. Two types of oils are distinguished: fluid oils extracted mainly from olive, peanut, sunflower, soya bean, rapeseed and wheat germ, which have the particularity of remaining liquid at 15° C.; and solid oils extracted from palm, from palm kernel and from copra (coconut) which are, on the other hand, set and solid at 15° C.

In the fields to which the present invention relates, the fats of animal and/or vegetable origin, and more particularly the butter, must have different properties depending on the main types of application intended.

Thus, for a “patisserie-product filling and topping” application, the rheological and organoleptic properties of the fats used must have, since the final product is consumed raw, a “fondant” impression in the mouth, without it being “tacky in the mouth”. In terms of texture, since the fat is overrun in the recipes of this type, the formulation must allow easy introduction of air which is stable over time. The excessively plastic nature of a fat, for instance margarine, is a handicap for this application, it being possible for too strong a cohesion of the fat to in fact reduce its overrun capacity.

For an “incorporation” application which groups together products of brioche or cake type or any other “egg-yolk dough” application, the fat must be dispersed, often rapidly, in the dough during kneading; it will therefore have to be easy to incorporate. The fat must therefore have a relatively weak consistency and a texture which is barely or not at all plastic, allowing good dispersibility thereof in the dough. A flexible fat which blends intimately with the other ingredients, with a melting point that is generally low since the doughs are worked at ambient temperature, is therefore sought.

Finally, regarding the “turn-and-roll and leavened puff pastry” application, the fats of origin used must have two essential properties: a high melting point and great plasticity. The plasticity allows the fat to spread easily upon rolling, but without breaking or rupturing. Furthermore, a considerable plasticity also makes it possible to be suitable for the mechanical stresses and to the heating undergone during rolling. These particularities result in the capacity to form a resistant and uniform film during rolling. Indeed, the turn-and-roll technique consists in interspersing by successive folding (folding and rolling and lamination) the layers of pastry (dough) and the layers of fat of the same thickness, which allows, during baking, the development of the product and the obtaining of separate sheets of pastry. The whole art of the dough maker will consist in obtaining textures of dough and of butter handled that are as close as possible, so as to promote spreading of the layers which is as uniform as possible. Leavened puff pastries (for croissants and other types of similar Viennese pastries) are produced on the basis of the same principle, but yeast is incorporated into the dough, there is less folding and rolling and the resulting pastry is placed in an oven before baking (“prior proofing before baking”). These pastries have great friability and a particular development due to the action of the yeast incorporated into the dough, but also through the development of the sheets of pastry obtained during the preparation of the successive folding of the dough with the butter.

The applicant has demonstrated that the reduced-fat-content fat according to the present invention can satisfy all the abovementioned specificities usually demanded of conventional fats. Thus, the reduced-fat-content fat has a very good technological, rheological and plastic behavior, and leads to final products having excellent qualities, this being regardless of the application intended. This makes it a principal ally in production units, in particular a single type of fat for several applications.

Another aspect of the invention also relates to a process for preparing a reduced-fat-content fat as described in the present document, characterized in that it comprises:
incorporating a microalgal flour, and optionally a drinkable liquid, into a fat of animal and/or vegetable origin as replacement for a part of said fat, and
cold storage.

In one preferential mode, the drinkable liquid is water and the fat is of animal origin and more preferentially butter.

In another preferential mode, the process for preparing the reduced-fat-content fat consists in premixing the microalgal flour and the water, so as to thoroughly hydrate the flour prior to its incorporation into the fat of origin.

This rehydration makes it possible to cause the microalgal granules to swell and then to allow them to be incorporated very well into the fat of origin. The formation of possible lumps is thus avoided and the softening of the reduced-fat-content fat is facilitated.

The rehydration is preferentially carried out by mixing with water, using from 10% to 90% of microalgal flour for 90% to 10% of water, the percentages being expressed by weight relative to the total weight of the mixture.

In one preferred mode of the invention, the degree of rehydration of the microalgal flour is 1 for 2. This rehydration therefore consists of approximately 33% of flour for 67% of water, expressed by weight. In another preferred mode of the invention, the degree of rehydration of the microalgal flour is 1 for 3. This rehydration therefore consists of 25% of flour used for 75% of water, expressed by weight.

In the case of prior rehydration of the microalgal flour, the process for preparing a reduced-fat-content fat as described in the present document is characterized in that it comprises:
mixing microalgal flour and water, at a ratio which can range from 1:9 to 9:1, preferably from 1:4 to 3:4 and even more preferably from 1:3 to 1:2,
incorporating a previously rehydrated microalgal flour into a fat of animal and/or vegetable origin as a replacement for a part of said fat, and
cold storage.

The ratio corresponds to a weight ratio, i.e. to the ratio of the weight of the algal flour to the weight of water.

Thus, the present invention also relates to a process for preparing a reduced-fat-content fat, in which the microalgal flour is rehydrated prior to its mixing with, or its incorporation into, a fat of animal and/or vegetable origin as a replacement for a part of said fat. The process according to the invention may thus comprise:
rehydrating the microalgal flour by mixing with a drinkable liquid, preferably water, according to a ratio of 1:9 to 9:1, preferentially 1:3 to 1:2,
mixing the rehydrated algal flour with a fat of animal and/or vegetable origin as a replacement for a part of said fat, and
cold storage.

In one preferred embodiment, the amount of fat replaced by weight corresponds substantially to the amount of rehydrated microalgal flour introduced into the reduced-fat-content fat. The term “corresponds substantially” is intended to mean the weight of fat replaced plus or minus 20%, 10% or 5%. Even more particularly, the amount of fat replaced by weight corresponds to the lipid content replaced, by weight.

In one preferential mode, the process for preparing a reduced-fat-content fat can itself also be characterized in that it comprises:
mixing a microalgal flour and water with a fat of animal and/or vegetable origin, and preferably butter,
storage at a temperature below 10° C. and preferably below 5° C. for a period greater than 5 hours, and preferably greater than 10 hours.

The particular characteristics of the granules of the microalgal flour used enable the latter to dissolve well when it is dissolved in water.

Thus, in one particular embodiment, the present invention relates to the use of the microalgal flour granules as described in the present document for the preparation of a reduced-fat-content fat.

Said process makes it possible to obtain a reduced-fat-content fat which has the texture of a softened gel, i.e. having rheological characteristics close to those of the fat generally used (butter and/or margarines).

Said softened fat is then incorporated into breadmaking, patisserie and/or Viennese pastry-making recipes in which it makes it possible to replace some of the fats of vegetable and/or animal origin conventionally used, while at the same time making it possible to meet the requirements of the production process used.

Another aspect of the present invention relates to a process for preparing a breadmaking, patisserie and/or Viennese pastry product, characterized in that it contains a reduced-fat-content fat as described in the present document, as partial replacement for fats of animal and/or vegetable origin.

Said process for preparing a breadmaking product is also characterized in that it comprises:
mixing the various ingredients until a dough is obtained, and
baking said dough.

Another aspect of the invention relates to a use of the reduced-fat-content fat as a partial replacement for the fats of animal and/or vegetable origin in the preparation of ganache and/or filling creams, both preferably likewise intended for the patisserie sector.

Ganache is a thick preparation of chocolate which is used to top a confectionery product or a patisserie product. In its simplest form, ganache is a mixture of cream (or sometimes of milk or butter, or even a mixture of the three) and of chocolate, generally in approximately equal amounts.

Milk fat fillings are all the mixtures obtained from sugar and from vegetable and/or animal fats, which traditionally contain milk proteins and which are intended to be used as filling in confectionery, patisserie, breadmaking, the cookie trade and any other area of food production. Such examples are, for example, praline-flavored fatty fillings and imitation “chocolate” fatty fillings.

Finally, a last aspect of the invention relates to the use of a reduced-fat-content fat as partial replacement for fats of animal and/or vegetable origin in a process for preparing a breadmaking, patisserie and/or Viennese pastry product.

The invention will be understood more clearly on reading the examples which follow, which are intended to be illustrative while referring only to certain embodiments and certain advantageous properties according to the invention, and nonlimiting.

### EXAMPLES

### Example 1: Production of the Microalgal Flour

A strain of Chlorella protothecoides (reference UTEX 250) is cultured in a fermenter and according to techniques known to those skilled in the art, in such a way that it does not produce chlorophyll pigment. The resulting biomass is then concentrated so as to obtain a final concentration of microalgal cells of 150 g/l.

The cells are optionally deactivated by heat treatment through an HTST (High Temperature/Short Time) zone at 85° C. for 1 minute.

For the rest of the operations, the temperature can be maintained under 8-10° C.

The washed biomass is then milled using a ball mill which may be of bead mill type, and several degrees of milling, in particular of lysis, are then sough: 50% milling and 85% milling.

In one of the embodiments, no milling is applied and the degree of milling is thus zero.

The biomass thus generated and optionally milled can then be pasteurized on an HTST zone (1 minute at 70-80° C.) and homogenized under pressure in a two-stage Gauvin homogenizer (250 bar at the 1st stage/50 bar at the second) after adjustment of the pH to 7 with potassium hydroxide.

Three batches of microalgal flour are thus obtained:
0% batch: no milling is applied;
50% batch: the degree of cell lysis after milling is 50%;
85% batch: the degree of cell lysis after milling is 85%.

According to the culture conditions applied, the lipid content of the microalgal biomass is greater than 35%, and the protein content less than 20%.

### Example 2: Drying of the Homogenized “Oil-in-Water” Emulsion of Microalgal Flour

The three batches of biomass obtained in example 1 are dried in a Filtermat device, so as to obtain the microalgal flour granules.

The spray-drying process consists in spraying the homogenized suspension at high pressure in a device of Filtermat type sold by the company GEA/Niro, fitted with a high-pressure injection nozzle of Delavan type, under the following conditions:
the pressure is regulated from 160 to 170 bar,
spray-drying input temperature: 180° C. to 200° C.,
output temperature: 60° C. to 80° C.,
drying zone input temperature: 60° C. to 90° C.,
output temperature: 65° C.,
cooling zone input temperature: 10° C. to 20° C.

The powder then reaches the belt with a residual moisture content of between 2% and 4%.

At the belt output: the microalgal flour granules have a residual moisture content of between 1% and 3%, about 2%.

### Example 3: Preparation of a Reduced-Fat-Content Fat

The starting fat is butter containing 82% fats.

Two reduced-fat-content fats according to the invention were prepared (with different final fat contents: 65% and 60%).

A. Preparation of a Reduced-Fat-Content Fat Containing 65% Fats

### Prior Rehydration of the Microalgal Flour

In a container, dissolve one measure by weight of microalgal flour for three measures by weight of water.
Leave the flour to thoroughly rehydrate on contact with the water for one hour at least at ambient temperature.
Prepare the reduced-fat-content fat by replacing 25% by weight of the butter with 25% of rehydrated microalgal flour.
Begin by making the starting butter into a paste so as to allow softening thereof.
Incorporate therein the previously hydrated microalgal flour.
Thoroughly mix the microalgal flour with the butter matrix by churning.
The mixture is then refrigerated so that the reduced-fat-content fat can harden. This should generally take at least 12 hours at 4° C.

### Final Composition of the Reduced-Fat-Content Fat According to the Invention

Starting butter: 75%
Microalgal flour at various degrees of milling: 6.2%
Water: 18.3%

B. Preparation of a Reduced-Fat-Content Fat Containing 60% Fats

The same degree of rehydration as that of example A is used, namely one measure by weight of microalgal flour for three measures by weight of water.

On the other hand, the reduced-fat-content fat is obtained by replacing 32% by weight of butter with 32% of rehydrated microalgal flour.

The preparation process is identical with also a refrigeration step.

### Final Composition of the Reduced-Fat-Content Fat According to the Invention

Starting butter: 68%
Microalgal flour at various degrees of milling: 8%
Water: 24%

### Example 4: Partial Replacement of the Fats for a Reduction in Calorie Content in a Pound-Cake Style Cake Formula

The two batches of microalgal flour at 0% and 85% milling, produced according to example 2, were tested in a cake application for a reduction in fat content and a reduction in calorie content.

A control test was carried out containing butter containing 82% fat.

Two tests: tests 1 and 2 were carried out with the fat having a fat content reduced to 65%, prepared according to example 3, for two degrees of milling of the flour of 0% and 85%.

Two other tests: tests 3 and 4 were also carried out with the fat having a fat content reduced to 60%, prepared according to example 3, for two degrees of milling of the flour of 0% and 85%.

The recipes are given in tables 1 and 2 below. They were the same regardless of the degrees of milling of the microalgal flour used.

The four tests and also the control were carried out on the same day.

TABLE 1
Tests with fat with a fat content reduced to 65%:

| | | | | With | | With | |
|---|---|---|---|---|---|---|---|
| | | | | reduced-fat- | | reduced-fat- | |
| | | | | content fat | | content fat | |
| | | | | and 0% | | and 85% | |
| | | | | milling | | milling | |
| | | Control | | TEST 1 | | TEST 2 | |
| | | g | % | g | % | g | % |
| A | 82% butter | 200.0 | 24.6% | 0 | 0 | 0 | 0 |
| | Fat of the | 0 | 0.0% | 200.0 | 24.6% | 200.0 | 24.6% |
| | invention | | | | | | |
| | 65%* | | | | | | |
| | Sucrose | 200.0 | 24.6% | 200.0 | 24.6% | 200.0 | 24.6% |
| B | Liquid | 200.0 | 24.6% | 200.0 | 24.6% | 200.0 | 24.6% |
| | whole eggs | | | | | | |
| | Vanilla extract | 5.0 | 0.6% | 5.0 | 0.6% | 5.0 | 0.6% |
| | Wheat flour | 200.0 | 24.6% | 200.0 | 24.6% | 200.0 | 24.6% |
| | Volcano | 5.0 | 0.6% | 5.0 | 0.6% | 5.0 | 0.6% |
| | chemical | | | | | | |
| | yeast | | | | | | |
| | Salt | 2.0 | 0.2% | 2.0 | 0.2% | 2.0 | 0.2% |
| | | 812.0 | 100% | 812.0 | 100% | 812.0 | 100% |

TABLE 2
Tests with fat with a fat content reduced to 60%:

| | | | | With | | With | |
|---|---|---|---|---|---|---|---|
| | | | | reduced-fat- | | reduced- | |
| | | | | content fat | | fat-content | |
| | | | | and 0% | | fat 85% | |
| | | | | milling | | milling | |
| | | Control | | TEST 3 | | TEST 4 | |
| | | g | % | g | % | g | % |
| A | 82% butter | 200.0 | 24.6% | 0 | 0 | 0 | 0 |
| | Fat of the | 0 | 0.0% | 200.0 | 24.6% | 200.0 | 24.6% |
| | invention 60%* | | | | | | |
| | Sucrose | 200.0 | 24.6% | 200.0 | 24.6% | 200.0 | 24.6% |
| B | Liquid whole eggs | 200.0 | 24.6% | 200.0 | 24.6% | 200.0 | 24.6% |
| | Vanilla extract | 5.0 | 0.6% | 5.0 | 0.6% | 5.0 | 0.6% |
| | Wheat flour | 200.0 | 24.6% | 200.0 | 24.6% | 200.0 | 24.6% |
| | Volcano | 5.0 | 0.6% | 5.0 | 0.6% | 5.0 | 0.6% |
| | chemical yeast | | | | | | |
| | Salt | 2.0 | 0.2% | 2.0 | 0.2% | 2.0 | 0.2% |
| | | 812.0 | 100% | 812.0 | 100% | 812.0 | 100% |

The Volcano chemical yeast is sold by the company Puratos, industrialaan 25, 1702 Groot-Bijgaarden, Belgium.

### Protocol for Preparing the Pound Cakes

Mix the butter, or the fat with a fat content reduced to 65% or 60%, with the sugar in the bowl of a mixer, until a creamy texture and complete dissolution of the sugar crystals are obtained.
Add the ingredients of group B to the previous mixture.
Mix everything together for 30 seconds at speed 1, then for 2 minutes at speed 2 and, finally, for 30 seconds at speed 3.
Place the cake mix in a greased aluminum mold (360 g).
Bake in an oven at 160° C. for 35 minutes.

### Analysis of the Final Products

The four pound-cake tests were tasted blind by a panel of tasters, and their taste was judged to be very satisfactory and pleasant. No difference in terms of texture, moistness or taste was demonstrated.

No significant difference was demonstrated when comparison was made with the control pound cake containing butter.

Thus, it is therefore possible to carry out pound-cake recipes using reduced-fat-content fats with fat contents of 65% or 60% (instead of the 82% traditionally encountered in butter) while obtaining products that are entirely satisfactory in terms of texture and taste. This reduction in fat through the partial replacement of a part of the starting butter with the reduced-fat-content fat according to the invention thus makes it possible to reduce the calorie content of the products and also the intake of bad fats.

The advantage of the present invention is thus demonstrated.

### Example 4: Preparation of Croissants

The objective of this example is to prepare croissants with a reduced-fat-content fat containing microalgal flour (degree of milling of 0% and 85%) with the objective of improving the nutritional profile of butter croissants. These croissants are then compared with the control formula of croissants with layering butter.

In this test, a part of the starting butter was replaced with the fat with a fat content reduced to 65%, prepared according to example 3, with the objective of giving the croissants a reduced-fat nutritional profile.

TABLE 3
Croissant composition:

| | Control croissants | | Reduced-fat croissants | |
|---|---|---|---|---|
| | g | % | g | % |
| Wheat flour | 980 | 41.0% | 980 | 41.0% |
| Gluten | 20 | 0.8% | 20 | 0.8% |
| Salt | 25 | 1.0% | 25 | 1.0% |
| Dried yeast (OSMO) | 16 | 0.7% | 16 | 0.7% |
| Sucrose | 110 | 4.6% | 110 | 4.6% |
| Whole eggs | 100 | 4.2% | 100 | 4.2% |
| Ascorbic acid | 0.2 | 0.01% | 0.2 | 0.01% |
| Nutrilife AM17 | 0.2 | 0.01% | 0.2 | 0.01% |
| Lametop 300 | 3 | 0.1% | 3 | 0.1% |
| Prefera SSL 600 | 5 | 0.2% | 5 | 0.2% |
| Water | 480 | 20.1% | 480 | 20.1% |
| Butter | 650 | 27.2% | 487 | 20.4% |
| Fat with fat content | 0 | 0.0% | 163 | 6.8% |
| reduced to 65% according | | | | |
| to the invention | | | | |
| TOTAL | 2389.4 | 100% | 2389.4 | 100% |

The formula for the dough into which the reduced-fat-content fat according to the invention is integrated is the same for the control croissants (conventional folding butter containing 84% fat) and for the “reduced-fat” croissants. The same proportions are used to carry out the turning and rolling (580 g of pastry=dough for 215 g of butter or of reduced-fat-content fat according to the invention).

### Croissant Preparation Protocol

Mix all the powders for 30 seconds at speed 1 in a kneading machine.
Add the water and the other liquid ingredients and mix for 10 minutes at speed 2.
Leave to stand in the refrigerator for 2 hours.
Carry out a lamination of the butter or of the reduced-fat-content fat (thickness 10 mm).
Carry out a lamination of the pastry (thickness of 8 mm) and insert the butter into the pastry. Fold.
Carry out lamination of the whole assembly (first 20 mm, then 12 mm, then 8 mm and finally 6.5 mm).
Carry out a “single turn” of the whole assembly.
Carry out lamination of the whole assembly (first 20 mm, then 12 mm, then 8 mm and finally 6.5 mm).
Carry out a “double turn” of the whole assembly.
Leave to stand for 30 minutes in the refrigerator.
Carry out lamination of the whole assembly (first 20 mm, then 12 mm, then 8 mm and finally 6.5 mm).
Carry out a “single turn” of the whole assembly.
Carry out lamination of the whole assembly (first 20 mm, then 12 mm, then 8 mm and finally 6.5 mm).
Carry out a “double turn” of the whole assembly.
Carry out a final lamination until a pastry thickness of 4 mm is obtained.
Shape the croissants.
Prove or proof in an oven at 26° C., 75% RH for 1 h 20 min.
Bake in an oven at 190° C. for 25 minutes.

### Observations Regarding the Kneading

The dough is formed conventionally. It is flexible and easy to handle.

In terms of shaping the croissants, better results are obtained with the vegetable butter containing flour of non-lyzed microalgae.

TABLE 4
Analysis of the croissants:

| | Control | With reduced-fat- |
|---|---|---|
| | butter | content fat |
| Calories (kCal/kJ) | 380 kCal/1589 kJ | 340 kCal/1422 kJ |
| Proteins | 6.1 | 6.1 |
| Fat content | 23.6 | 18.9 |
| Carbohydrates | 36.0 | 36.3 |
| Of which DP 1, 2 | 5.0 | 5.1 |
| Total fibers | 0.8 | 1.3 |
| | Fat reduction | 19.1% |
| | Calorie reduction | 10.0% |

The croissants obtained were tasted by a trained jury and were compared with the “pure butter” control croissants. Their texture was judged to be flaky and light and their taste very close to the taste of the control croissants. In other words, the croissants containing the reduced-fat-content fat according to the present invention were judged to be very good in visual terms and in terms of color, texture and taste.

Thus, it is possible to replace a part of the fats of animal origin with a reduced-fat-content fat according to the present invention. The reduction in fat is 19% in this test. The croissants obtained are similar in terms of quality to the croissants obtained according to the pure butter recipe, the latter having a much higher calorie content.

### Example 5: Preparation of Shortcrust Pastry

### Shortcrust Pastry Composition

500 g of flour
200 g of 65% vegetable fat prepared according to example 3
10 g of salt
100 g of sugar
110 g of egg
50 g of water

### Preparation Protocol

Mix the powders (flour, salt, sugar) well with the fat in a blender for 3 min at speed 2.
Add the eggs and the water and mix the whole assembly for two minutes at speed 2.
Roll out the pastry, top it and bake the whole assembly.

In parallel, the same recipe was prepared with 200 g of butter of animal origin.

The two pastries were baked without topping and tested blind.

No significant difference could be noted between the two.

This recipe allows partial replacement of the fats of animal origin and a reduction in fat of approximately 20%.

The advantage of the present invention is thus demonstrated.

1-20. (canceled)

21. A reduced-fat-content fat comprising a modified lipid content, wherein at least 5% of the lipid content is replaced with a microalgal flour, said microalgal flour having a monomodal particle size distribution of between 2 and 400 μM; a flow grade, determined according to a test A of between 0.5% and 60% by weight for the oversize at 2000 μM; and a degree of wettability, determined according to a test B, wherein the height of the reduced-fat-content fat decanted in a beaker is between 0 and 4 cm.

22. The reduced-fat-content fat of claim 21, wherein at least 10% of the lipid content is replaced with a microaglal flour.

23. The reduced-fat-content fat of claim 21, wherein at least 40% of the lipid content is replaced with a microaglal flour.

24. The reduced-fat-content fat of claim 21, wherein at least 60% of the lipid content is replaced with a microaglal flour.

25. The reduced-fat-content fat of claim 21, wherein said fat comprises at least 40% of fat, expressed by dry weight.

26. The reduced-fat-content fat of claim 21, wherein said fat comprises from 50% to 95% of fat, expressed by dry wright.

27. The reduced-fat-content fat of claim 21, said fat also comprising a drinkable liquid.

28. The reduced-fat-content fat of claim 27, wherein the drinkable liquid is selected from the group consisting of water, fruit juice, fruit nectar, vegetable juice, vegetable nectar and soda.

29. The reduced-fat-content fat of claim 21, wherein said fat comprises from 30% to 90% of fat of animal and/or vegetable origin and from 0.5% to 50% of microalgal flour, the percentages being indicated by weight on the reduced-fat-content fat.

30. The reduced-fat-content fat of claim 27, wherein said fat contains from 30% to 90% of fat of animal and/or vegetable origin and from 0.5% to 50% of microalgal flour and from 1% to 40% of drinkable liquid, the percentages being indicated by weight of the reduced-fat-content fat.

31. The reduced-fat-content fat of claim 21, wherein the monomodal particle size distribution is between 2 and 400 μm, centered on a particle diameter (D mode) between 5 and 15 μm.

32. The reduced-fat-content fat of claim 21, wherein the microalgal flour is a flour of a microalgae of the Chlorella genus.

33. The reduced-fat-content fat of claim 32, wherein the microalgal flour of the Chlorella genus is of the Chlorella protothecoides species.

34. The reduced-fat-content fat of claim 21, wherein the microalgal flour comprises at least 12% lipid by dry weight.

35. The reduced-fat-content fat of claim 21, wherein the microalgal flour comprises at least 25% lipid by dry weight.

36. The reduced-fat-content fat of claim 21, wherein the microalgal flour comprises at least 50% lipid by dry weight.

37. The reduced-fat-content fat of claim 21, wherein the microalgal flour comprises at least 75% lipid by dry weight.

38. A process for preparing a reduced-fat content fat, wherein at least 5% of the lipid content is replaced with the microalgal flour of claim 21, the method comprising:
incorporating a microalgal flour, and optionally a drinkable liquid, into a fat of animal and/or vegetable origin as replacement for a part of said fat.

39. The process of claim 38, wherein said incorporating comprises:
mixing said mircroalgal flour and water with a fat of animal and/or vegetable origin; and
storing said fat at a temperature below 10° C. for a period greater than 5 hours.

40. The process of claim 39, wherein said mixing comprises:
mixing said microaglal flour and water at a ratio ranging from 1:9 to 9:1 to prepare rehydrated microalgal flour; and
incorporating said rehydrated microalgal flour into a fat of animal and/or vegetable origin as a replacement for a part of said animal or vegetable fat.

41. The process of claim 40, wherein the ratio of the microalgal flour and water is between 1:3 and 1:2.
